(19) United States
(12) Patent Application Publication
(10) Pub. No.: US 2023/0057060 A1
(43) Pub. Date: Feb. 23, 2023

(54) TEST COMPONENT EXTRACTION MODULE

(71) Applicants: Sheng-Hung WANG, Taoyuan City (TW); Po-Hsiang CHANG, Taoyuan City (TW); Mei-Cheng LAI, Taoyuan City (TW)

(72) Inventors: Sheng-Hung WANG, Taoyuan City (TW); Po-Hsiang CHANG, Taoyuan City (TW); Mei-Cheng LAI, Taoyuan City (TW)

(21) Appl. No.: 17/886,498

(22) Filed: Aug. 12, 2022

(30) Foreign Application Priority Data
Aug. 17, 2021 (TW) 110130185

(51) Int. Cl. G01N 35/10; G01N 35/00

(52) U.S. Cl. CPC G01N 35/10; G01N 35/0099; G01N 2035/1051

(57) ABSTRACT

The present invention provides a test component extraction module having a first arm, a second arm, and a base. The second arm is connected to the first arm. The base is connected to the second arm and has a suction hole for holding a test component. Wherein a first angle is predetermined between the first arm and the second arm. When the suction hole sucks the test component attached to a surface, and the first arm gradually moves away from the surface, a second angle is between the second arm and the first arm, and the second angle is greater than the first angle.

### BACKGROUND OF THE INVENTION

### Cross Reference to Related Application

The present application claims priority to Taiwan patent application Serial No. 110130185 filed on Aug. 17, 2021 the entire content of which is incorporated by reference to this application.

### 1. FIELD OF THE INVENTION

The present invention pertains to a test component extraction module, more specifically to a test component extraction module for non-horizontal extraction.

### 2. DESCRIPTION OF THE PRIOR ART

With the development of technology, the size of precise mechanical components or electronic components is getting smaller and smaller, and how to efficiently and stably move these components by an extraction device has become a very important issue. For example, the size of the traditional LEDs is relatively large, and the corresponding extraction device can still move the LEDs in a clamping manner. However, the size of the current LEDs is already in the micrometer or nanometer scale such as micro LEDs, it is very inefficient to pick up the LEDs one by one, and it is also easy to damage the LEDs. In addition, the LEDs may also be placed on objects of various shapes, but some of the shapes might be relatively difficult for picking up LEDs. For example, when the extraction device picks up LEDs disposed on a strip-shaped object, it is to break the strip-shaped object due to uneven force. In particular, in order to increase the stability during transportation, the strip-shaped object may have been attached or adhered to a transportation substrate in advance. Person having ordinary skill in the art can understand that the extraction device will be more difficult to pick up the strip-shaped object substrate attached or adhered to the transportation substrate.

Accordingly, the industry needs a new equipment for extracting the test component (DUT), which can correspondingly pick up the test components of various shapes, and can prevent the test components from being damaged.

### SUMMARY OF THE INVENTION

The present invention provides a test component extraction module, which can obliquely pick up the test component that is adhered to any surface. The test component extraction module can reduce the force required to pick up the test component, and can prevent the test component from being damaged.

The present invention provides a test component extraction module having a first arm, a second arm, and a base. The second arm is connected to the first arm. The base is connected to the second arm and has a suction hole for holding a test component. Wherein a first angle is predetermined between the first arm and the second arm. When the suction hole sucks the test component attached to a surface, and the first arm gradually moves away from the surface, a second angle is between the second arm and the first arm, and the second angle is greater than the first angle.

In some embodiments, the first arm may have a first connecting end, a first end, and a second end, the first connecting end is located between the first end and the second end, the second arm may have a second connecting end, a third end, and a fourth end, the second connecting end is located between the third end and the fourth end, the third end may be adjacent to the first end, the fourth end may be adjacent to the second end, and the second connecting end may be pivoted on the first connecting end. In addition, an elastic element may be disposed between the third end and a bottom surface of the first arm, and the elastic element is configured to maintain a predetermined distance between the third end and the bottom surface. When the suction hole sucks the test component attached to the surface, and the first arm gradually moves away from the surface, the distance between the third end and the bottom surface may be smaller than the distance between the fourth end and the bottom surface. When the suction hole sucks the test component attached to the surface, and the first arm gradually moves away from the surface, the distance between the third end and the bottom surface may be less than the predetermined distance.

In some embodiments, the first arm may have a first end and a second end, the second arm may have a third end and a fourth end, and the distance between the first arm and the third end may be smaller than the distance between the first arm and the fourth end. When the suction hole sucks the test component attached to the surface, and the first arm gradually moves away from the surface, the fourth end may gradually move away from the second end. Besides, the second arm may be a reed and has a predetermined shape, when the suction hole sucks the test component attached to the surface, and the first arm gradually moves away from the surface, the shape of the second arm may be different from the predetermined shape. When the test component is separated from the surface, the shape of the second arm may return to the predetermined shape. After the test component is separated from the surface, the first angle may be restored between the first arm and the second arm. The first arm may be configured to move between a first position and a second position in a vertical direction relative to the surface.

To sum up, the test component extraction module provided by the present invention can remove the test component attached to the surface in a non-horizontal manner. Different from the traditional manner for extracting the test component horizontally, the test component extraction module of the present invention can lift one end of the test component first, and then pull the test component completely away from the surface, thereby reducing the time and the force required to pick up the test component, and preventing the test component from being damaged.

### BRIEF DESCRIPTION OF THE APPENDED DRAWINGS

FIG. 1 illustrates a perspective view of a test component extraction module according to an embodiment of the present invention.

FIG. 2 illustrates a side view of the test component extraction module according to an embodiment of the present invention.

FIG. 3 illustrates an exploded side view of the test component extraction module according to an embodiment of the present invention.

FIG. 4 illustrates a bottom view of the test component extraction module according to an embodiment of the present invention.

FIG. 5 illustrates a perspective view of a test component extraction module according to another embodiment of the present invention.

FIG. 6 illustrates a side view of the test component extraction module according to another embodiment of the present invention

FIG. 7 illustrates an exploded side view of the test component extraction module according to another embodiment of the present invention

FIG. 8 illustrates a bottom view of the test component extraction module according to another embodiment of the present invention.

### DETAILED DESCRIPTION OF THE INVENTION

The features, targetions, and functions of the present invention are further disclosed below. However, it is only a few of the possible embodiments of the present invention, and the scope of the present invention is not limited thereto; that is, the equivalent changes and modifications done in accordance with the claims of the present invention will remain the subject of the present invention. Without departing from the spirit and scope of the invention, it should be considered as further enablement of the invention.

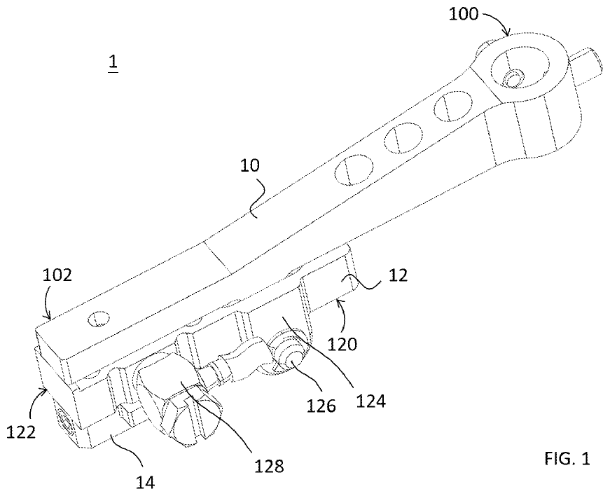

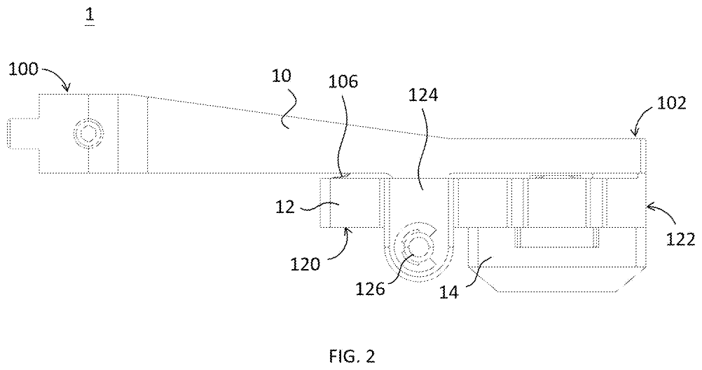

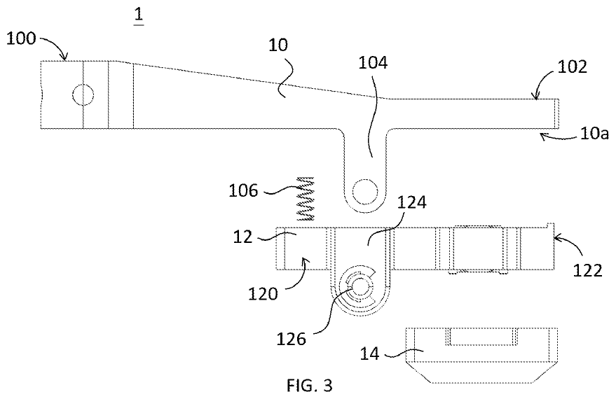

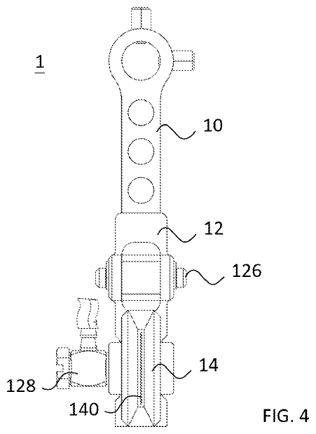

Please refer to FIG. 1 to FIG. 4 together. FIG. 1 illustrates a perspective view of a test component extraction module according to an embodiment of the present invention, FIG. 2 illustrates a side view of the test component extraction module according to an embodiment of the present invention, FIG. 3 illustrates an exploded side view of the test component extraction module according to an embodiment of the present invention, and FIG. 4 illustrates a bottom view of the test component extraction module according to an embodiment of the present invention. As shown in the figures, the test component extraction module 1 has a first arm 10, a second arm 12 and a base 14. The first arm 10 and the second arm 12 in this embodiment should preferably be rigid material, that is, they are not easy to be bent by external force. Two ends of the first arm 10 are respectively defined as a first end 100 and a second end 102, and a first connecting end 104 is provided between the first end 100 and the second end 102. In practice, the first end 100 can be fixedly connected to an external lifting unit, and the external lifting unit can move vertically upwards and downwards. At this time, due to the better rigidity of the first arm 10, when the first end 100 is moved by the external lifting unit, the second end 102 will also move together with the first end 100, and the relative position of the first end 100 and the second end 102 should remain unchanged.

Two ends of the second arm 12 are respectively defined as a third end 120 and a fourth end 122, and a second connecting end 124 is provided between the third end 120 and the fourth end 122. In practice, the second connecting end 124 can be pivotally connected to the first connecting end 104, so that the second arm 12 can be movably connected to the first arm 10. As shown in the figures, the first connecting end 104 and the second connecting end 124 may be respectively provided with corresponding holes, and the first connecting end 104 may be inserted into the second connecting end 124. That is to say, when the first connecting end 104 has been correctly inserted into the second connecting end 124, the first connecting end 104 and the second connecting end 124 can be fixed by one rotating shaft 126 inserted into the holes of the first connecting end 104 and the second connecting end 124. In one example, when the first end 100 of the first arm 10 is fixedly connected to the external lifting unit, it can be considered that the first arm 10 is fixed and only the second arm 12 can move, relative to the first arm 10. Person having ordinary skill in the art should understand that the second arm 12 will rotate around the shaft 126, that is, either the third end 120 moves toward a bottom surface 10a of the first arm 10, or the fourth end 122 moves toward the bottom surface 10a of the first arm 10.

It is worth mentioning that an elastic element 106 may also be provided between the first arm 10 and the second arm 12, and the elastic element 106 is configured to maintain the relative position of the first arm 10 and the second arm 12. In one example, the elastic element 106 may be disposed between the third end 120 of the second arm 12 and the bottom surface 10a of the first arm 100 to maintain a predetermined distance between the third end 120 and the bottom surface 10a. Of course, the elastic element 106 shown in the figures is only an example, and the present embodiment does not limit the type and the position of the elastic element 106 as long as the relative position between the first arm 10 and the second arm 12 can be maintained. It is also possible that the elastic element 106 is not required. For example, the elastic element 106 may be disposed between the fourth end 122 and the bottom surface 10a, or the rotating shaft 126 may be changed to a rotating shaft that can memorize the predetermined shape/position and can be reset, that is, it is not necessary to provide another elastic element 106.

The base 14 is connected to the second arm 12 and is provided with a suction hole 140, and the suction hole 140 can be used for sucking the test component (not shown). In practice, an air passage (not shown) may be provided inside the base 14 to connect the suction hole 140 with an external extraction device. In one example, the air passage may extend from the inside of the base 14 to the inside of the second arm 12, and a suction assembly 128 is provided on the second arm 12. Then, the suction assembly 128 can be connected to the external extraction device (not shown). Of course, this embodiment does not limit the positions of the air passage, the suction assembly 128, or the external extraction device, and person having ordinary skill in the art can freely design as needed. In addition, the shape of the suction hole 140 roughly corresponds to the shape of the test component, as long as the test component can cover the suction hole 140, so that the suction hole 140 and the test component can be airtight. For example, the suction hole 140 may be in the shape of a strip or a circle, and if there are more than one suction hole 140, the suction holes can be arranged in random position or array. In one example, the test component corresponding to the embodiment may be strip-shaped, so the suction hole 140 shown in FIG. 4 is also strip-shaped. It is worth mentioning that, although the test component extraction module 1 of this embodiment can be applied to test components of various shapes, it might have more prominent effects when applied to the strip-shaped test component.

In practice, assuming that the test component is a LED, which is usually placed in a corresponding position on the film or carrier, waiting to be picked up for testing. It is necessary to keep the test component in its original position regardless the vibration during transportation or handling, which might be critical for aligning and extracting. For example, the surface of the film or carrier may be sticky, so that the test component can be glued to the surface. Traditionally, if the shape of the test component is a strip, it is often difficult to extract the test component because the structure of the strip-shaped test component is weak, and the test component has been adhered to the surface of the film or carrier. The test component can be easily broken or damaged during the traditional extraction process.

According to an embodiment of the present invention, when the test component extraction module 1 picks up the test component attached to the surface, the first arm 10 will be lowered to a predetermined height in the vertical direction by the connected lifting unit. The predetermined height (e.g., the first position), for example, should allow the suction hole 140 of the base 14 to just touch the test component. Since the external extraction device is connected to the suction hole 140 through the air passage and the suction assembly 128, the external extraction device can substantially vacuum the test component which covers the suction hole 140, so that the test component can be closely attached to the suction hole 140. Then, the external lifting unit connected to the first arm 10 can be gradually raised in the vertical direction, thereby driving the first arm 10 to rise (e.g., to the second position) and gradually move away from the surface on which the test component is placed. At this time, because the first connecting end 104 and the second connecting end 124 have been fixed, the second arm 12 is also driven by the first arm 10 to rise. Because the first connecting end 104 and the second connecting end 124 are only pivotally connected, the second arm 12 is not necessarily parallel to the first arm 10.

Person having ordinary skill in the art can understand that when the second arm 12 is raised by the first arm 10, the second arm 12 should be subjected to forces in two different directions. One of the forces is the upward force provided by the first arm 10, and the other is the force of the second arm 12 being pulled down by the base 14. In detail, the force from the base 14 is due to the fact that one side of the test component is closely attached to the suction hole 140 of the base 14, wherein the test component is still stuck to the film or the carrier surface, so the base 14 will have a downward pulling force. In practice, in order to balance the two forces, the fourth end 122 of the second arm 12 will be pulled toward the test component (away from the bottom surface 10a), and the third end 120 will be pulled towards the bottom surface 10a. In one example, the fourth end 122 remains lower than the third end 120 until the downward pulling force disappears, that is, the test component is completely pulled up from the surface of the film or the carrier.

If the second arm 12 is parallel to the first arm 10 in a predetermined state, for example, the angle between the first arm 10 and the second arm 12 is 0-degree (a first angle). When the test component is pulled up from the surface of the film or the carrier, since the fourth end 122 of the second arm 12 is inclined lower than the third end 120, the first arm 12 and the second arm 12 will no longer be parallel, and the angle between the first arm 10 and the second arm 12 should be larger (a second angle) than the first angle. In one example, because the present embodiment is provided with the elastic element 106, after the test component is pulled up from the surface of the film or the carrier, the second arm 12 may return to the predetermined state which is parallel to the first arm 10 again, and the distance between the third end 120 and the bottom surface 10a is restored to the predetermined distance.

It is worth mentioning that when the test component has not been entirely pulled up, the second arm 12 is inclined, and the test component should start to leave (or peel from) the film or the carrier from one end (near the third end 120). That is, not all places of the test component are peeled from the film or carrier at the same time. The advantage is that when the test component is strip-shaped, the test component can be removed from the surface of the film or the carrier smoothly like a sticker is torn off. Person having ordinary skill in the art can imagine that it is relatively difficult to extract both ends of the strip-shaped test component at the same time, but it is much easier to extract the strip-shaped test component from one end. Of course, because the suction hole 140 of the base 14 has already sucked the test component tightly, the test component extraction module 1 can prevent the test component from being bended or damaged during the smooth extraction process.

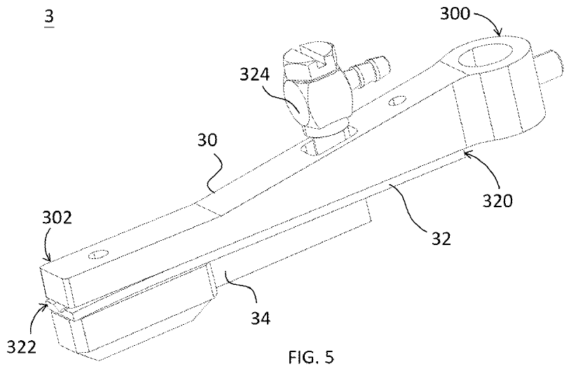

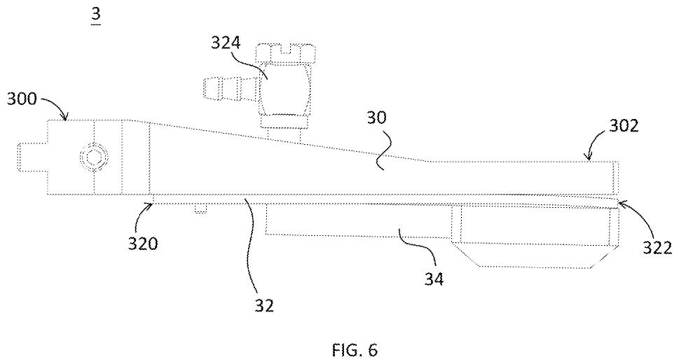

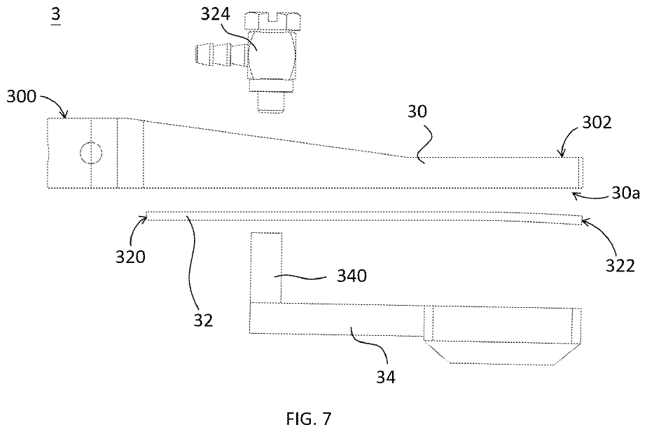

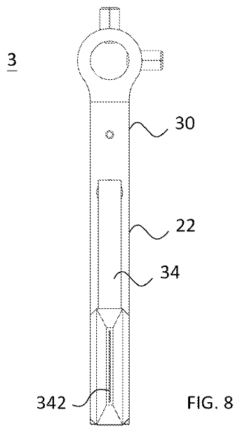

As can be seen from FIG. 1 to FIG. 4, the second arm 12 of the test component extraction module 1 uses the second connecting end 124 and the rotating shaft 126 as a fulcrum, and the third end 120 and the fourth end 122 can swing like a seesaw. However, the present invention is not limited to this configuration. The present invention can also have another design of the test component extraction module. Please refer to FIG. 5 to FIG. 8 together. FIG. 5 illustrates a perspective view of a test component extraction module according to another embodiment of the present invention, FIG. 6 illustrates a side view of the test component extraction module according to another embodiment of the present invention, FIG. 7 illustrates an exploded side view of the test component extraction module according to another embodiment of the present invention, FIG. 8 illustrates a bottom view of the test component extraction module according to another embodiment of the present invention. Similar to the previous embodiment, the test component extraction module 3 also has a first arm 30, a second arm 32, and a base 34. Two ends of the first arm 30 can be respectively defined as a first end 300 and a second end 302, and two ends of the second arm 32 can be respectively defined as a third end 320 and a fourth end 322. The first end 300 of the first arm 30 can also be fixedly connected to an external lifting unit, and the external lifting unit can move vertically upwards and downwards. The base 34 is also connected to the second arm 32 and is provided with an suction hole 342, and the suction hole 342 can be used for sucking a test component (not shown in the figures). In addition, the base 34 is further provided with an air passage 340, one end of the air passage 340 can be connected to the suction hole 342, and the other end of the air passage 340 can extend from the base 34 to the inside of the second arm 32. An suction assembly 324 can be disposed on the second arm 32 and connected to an external extraction device (not shown). Since the functions of the first arm 30 and the base 34 are the same as those of the previous embodiment, the description in this embodiment will not be repeated.

Different from the previous embodiment, the second arm 32 of the test component extraction module 3 does not swing like a seesaw, but can be a reed or a spring. As shown in FIG. 6 and FIG. 7, although the first arm 30 and the second arm 32 are still fixed together, but there is no first connecting end and second connecting end pivotally connected like the previous embodiment. The third end 320 of the second arm 32 is fixed to the first arm 30 to avoid relative movement between the third end 320 and the first arm 30. Besides, the third end 320 of the second arm 32 may be closer to the first end 300 of the first arm 30 than the fourth end 322. From the overall appearance of the second arm 32 as a whole, the second arm 32 may be bent adjacent to the fourth end 322. That is, when the third end 320 of the second arm 32 contacts the first arm 30, it still leaves a gap between the fourth end 322 of the second arm 32 and the second end 302 of the first arm 30. In other words, the distance between the first arm 30 and the third end 320 is smaller than the distance between the first arm 30 and the fourth end 322.

In an operational example, when the test component extraction module 3 is about to pick up the test component attached to the surface, the first arm 30 will be lowered to a predetermined height in the vertical direction by the connected lifting unit. The predetermined height (e.g., the first position), for example, should allow the suction hole 342 of the base 34 to just touch the test component. Since the external extraction device is connected to the suction hole 342 via the air passage 340 and the suction assembly 324, the external extraction device can evacuate the space between the suction hole 342 and the test component to a substantially vacuum, so that the test component is closely attached to the suction hole 342. Then, the external lifting unit connected to the first arm 30 can be gradually raised in the vertical direction, thereby driving the first arm 30 to rise (e.g., to the second position) and gradually move away from the surface on which the test component is placed. At this time, because the third end 32 of the second arm 32 has been fixed to the first arm 30, the second arm 32 is also driven by the first arm 30 to rise.

As in the previous embodiment, when the second arm 32 is raised by the first arm 30, the second arm 32 should be subjected to two forces in different directions. One of the two forces is the upward force provided by the first arm 30, and the other is the downward provided by the second arm 32 being pulled down by the base 34. At this time, the fourth end 322 of the second arm 32 will be pulled toward the surface where the test component is located, away from the bottom surface 30a of the first arm 30. Person having ordinary skill in the art should understand that when the test component has not been completely pulled up from the surface of the film or the carrier, since the second arm 32 has elasticity, the second arm 30 is lifted and more bent as the first arm 30 is raised. That is to say, assuming that the second arm 32 has a predetermined shape (like a predetermined bending angle, the first angle), when the suction hole 342 sucks the test component attached to the surface, and the first arm 30 gradually moves away from the aforementioned surface, the shape of the second arm 32 can be different from the predetermined shape (like more bent, the second angle). In practice, the deformation of the second arm 32 will be maintained until one of the forces disappears, that is, until the test component is completely pulled up from the surface of the film or the carrier. In one example, because the second arm 32 of this embodiment may be elastic, such as a reed, after the test component is completely pulled up from the surface of the film or the carrier, the second arm 32 can be in the predetermined shape again.

To sum up, the test component extraction module provided by the present invention can remove the test component attached to the surface in a non-horizontal manner. Different from the traditional manner for extracting the test component horizontally, the test component extraction module of the present invention can lift one end of the test component first, and then pull the test component completely away from the surface, thereby reducing the time and the force required to pick up the test component, and preventing the test component from being damaged.

What is claimed is:

1. A test component extraction module, comprising:
a first arm;
a second arm connected to the first arm; and
a base, connected to the second arm, having a suction hole for holding a test component;
wherein a first angle is predetermined between the first arm and the second arm;
wherein when the suction hole sucks the test component attached to a surface, and the first arm gradually moves away from the surface, a second angle is between the second arm and the first arm, and the second angle is greater than the first angle.

2. The test component extraction module according to claim 1, wherein the first arm has a first connecting end, a first end, and a second end, the first connecting end is located between the first end and the second end, the second arm has a second connecting end, a third end, and a fourth end, the second connecting end is located between the third end and the fourth end, the third end is adjacent to the first end, the fourth end is adjacent to the second end, and the second connecting end is pivoted on the first connecting end.

3. The test component extraction module according to claim 2, wherein an elastic element is disposed between the third end and a bottom surface of the first arm, and the elastic element is configured to maintain a predetermined distance between the third end and the bottom surface.

4. The test component extraction module according to claim 3, wherein when the suction hole sucks the test component attached to the surface, and the first arm gradually moves away from the surface, the distance between the third end and the bottom surface is smaller than the distance between the fourth end and the bottom surface.

5. The test component extraction module according to claim 3, wherein when the suction hole sucks the test component attached to the surface, and the first arm gradually moves away from the surface, the distance between the third end and the bottom surface is less than the predetermined distance.

6. The test component extraction module according to claim 1, wherein the first arm has a first end and a second end, the second arm has a third end and a fourth end, and the distance between the first arm and the third end is smaller than the distance between the first arm and the fourth end.

7. The test component extraction module according to claim 6, wherein when the suction hole sucks the test component attached to the surface, and the first arm gradually moves away from the surface, the fourth end gradually moves away from the second end.

8. The test component extraction module according to claim 6, wherein the second arm is a reed and has a predetermined shape, when the suction hole sucks the test component attached to the surface, and the first arm gradually moves away from the surface, the shape of the second arm is different from the predetermined shape.

9. The test component extraction module according to claim 8, wherein when the test component is separated from the surface, the shape of the second arm returns to the predetermined shape.

10. The test component extraction module according to claim 1, wherein after the test component is separated from the surface, the first angle is restored between the first arm and the second arm.

11. The test component extraction module according to claim 1, wherein the first arm is configured to move between a first position and a second position in a vertical direction relative to the surface.
